(19) United States
(12) Patent Application Publication
(10) Pub. No.: US 2026/0279710 A1
(43) Pub. Date: Sep. 17, 2026

(54) Threaded Part, and Contactor

(71) Applicant: ABB Schweiz AG, Baden (CH)

(72) Inventors: Yoann Granier, Vienne (FR); Mikayil Gozukara, Vaulx-en-Velin (FR)

(73) Assignee: ABB Schweiz AG, Baden (CH)

(21) Appl. No.: 19/561,074

(22) Filed: Mar. 9, 2026

(30) Foreign Application Priority Data
Mar. 13, 2025 (EP) 25163607.2

(51) Int. Cl. H01H 50/14

(52) U.S. Cl. CPC H01H 50/14

(57) ABSTRACT

A threaded part includes a body having first and second sides, a threaded hole extending perpendicularly through the body from the first side to the second side, and at least one groove formed in the body. The is configured to fit into a contactor pocket with the first side oriented toward the terminal screw, and the threaded hole oriented toward the terminal screw, and the at least one groove extends from the first side toward the second side of the body such that a depth of the at least one groove is less then a thickness of the body and the at least one groove extends over at least a thread of the threaded hole.

### CROSS-REFERENCE TO RELATED APPLICATIONS

The instant application claims priority to European Patent Application No. EP25163607.2, filed Mar. 13, 2025, which is incorporated herein in its entirety by reference.

### FIELD OF THE DISCLOSURE

The present disclosure generally relates to a threaded part and, more particularly, to a threaded part for us with screw terminals in contactors and to a contactor with the threaded part.

### BACKGROUND OF THE INVENTION

Threaded components can be integrated into contactor covers and serve as the attachment points for terminal screws. They can be either be molded directly into the covers or designed as separate inserts. These inserts are specifically shaped to fit into designated terminal pockets within the cover. Some embodiments incorporate expansion or locking elements to secure the insert in position. However, the threaded parts known from the prior art have a rigid body. This rigidity may lead to assembly-related issues, particularly in cases of misalignment during installation.

When wire ferrules are improperly positioned, terminal screws intended to engage with the threaded part may encounter significantly increased resistance during installation. As a result, an unintended increase in assembly force can cause the combination of the threaded part and the terminal screw to transfer excessive loads to the surrounding assembly, often resulting in damage to individual components during the assembly process.

A mere reduction in the load capacity of a threaded part does not present a viable solution. In assembly conditions where elevated forces are exerted, such a modification may compromise the structural integrity of the insert, potentially leading to its deformation or failure. Additionally, a weakened insert may be unable to sustain the required preload of the connection, thereby undermining its intended function. Consequently, this could result in mechanical failures that disrupt the reliable operation of the contactor.

### BRIEF SUMMARY OF THE INVENTION

The present disclosure generally describes an improved threaded part solution that mitigates the effects of excessive assembly forces while maintaining secure and reliable ferrule attachment to the contactor.

In one aspect, the present disclosure describes a threaded part for use with a contactor terminal screw, comprising: a body comprising a first side and a second side opposite to the first side, a threaded hole extending perpendicularly through the body from the first side, and an at least one groove formed in the body, wherein the body is configured to fit into a terminal pocket with the first side oriented toward the terminal screw, and the threaded hole oriented toward the terminal screw, and the at least one groove extends from the first side toward the second side of the body such that a depth of the at least one groove is smaller than a thickness of the body, and the at least one groove extends over at least a thread of the threaded hole.

### BRIEF DESCRIPTION OF THE SEVERAL VIEWS OF THE DRAWINGS

FIG. 1 is an outline view of a prior art threaded part.

FIG. 2 is an outline view of a contactor with prior art threaded part that is damaged during installation.

FIG. 3 is a closeup view of a known contactor having a coaxially positioned ferrule.

FIG. 4 is a closeup view of a contactor with a misaligned ferrule.

FIG. 5 is a first view showing a groove of a threaded part in accordance with the disclosure.

FIG. 6 is a second view showing recesses of a threaded part in accordance with the disclosure.

FIG. 7 is a cross section of a contactor with misaligned ferrule in accordance with the disclosure.

FIG. 8 is a closeup view of a portion of the cross section of FIG. 7 depicting forces in the threaded connection.

FIG. 9 is a cross section of a contactor during unscrewing in accordance with the disclosure.

FIG. 10 is a closeup view of a portion of the cross section of FIG. 9 depicting forces in the threaded connection.

FIG. 11 is a partially disassembled view showing a direction of threaded part deflection in the situation of a misaligned ferrule during installation, in accordance with the disclosure.

FIG. 12 is a partially disassembled view showing threaded part deflection during unscrewing, in accordance with the disclosure.

### DETAILED DESCRIPTION OF THE INVENTION

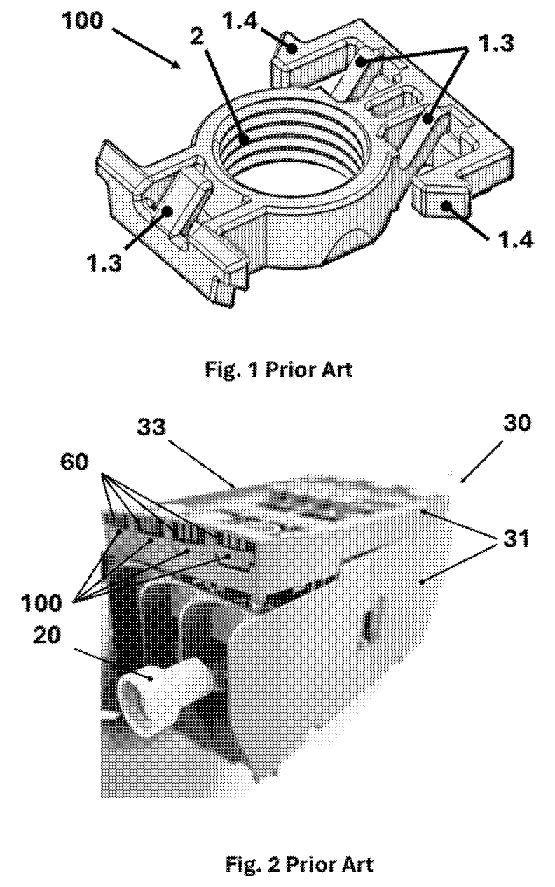

It is noted that in the description of the figures, same reference numerals refer to the same of similar components performing a same of essentially similar function. FIG. 1 depicts a prior art threaded part 100. The threaded hole 2 is positioned near the center of a body 1. The body 1 is rigid, shaped to fit a terminal pocket 60 of a screw connecting terminal 32 in a contactor 30. The body 1 comprises expanding elements 1.3 and locking elements 1.4.

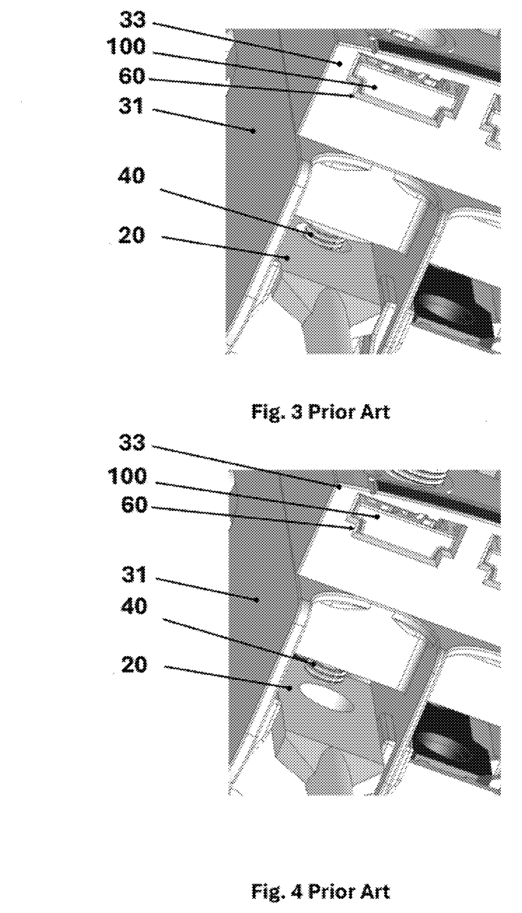

FIG. 2 depicts a contactor 30, with the prior art threaded parts 100, damaged during installation. The forces in the threaded connection exceeded the strength of the components, causing permanent deformations. This was due to the misalignment of a ferrule 20, which led to a terminal screw 40 blocking on it. FIG. 4 depicts visualisation of this. Comparatively, in FIG. 3 depicts a correct position of the ferrule 20 on a fixed contact 70.

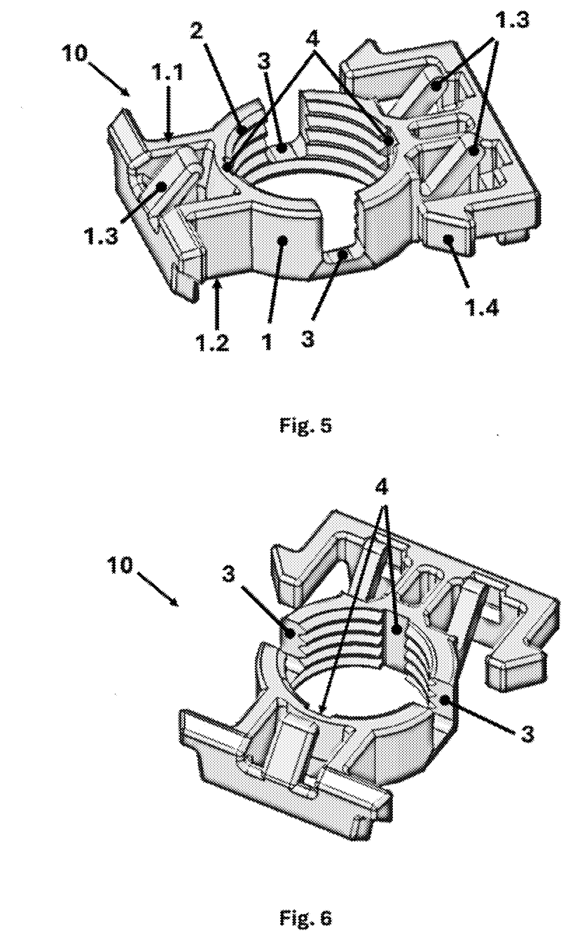

FIGS. 5 and 6 depict a new design of a threaded part 10, which is the subject of the present invention. This embodiment discloses the threaded part 10 as an independent element. The body 1 is in form of an insert.

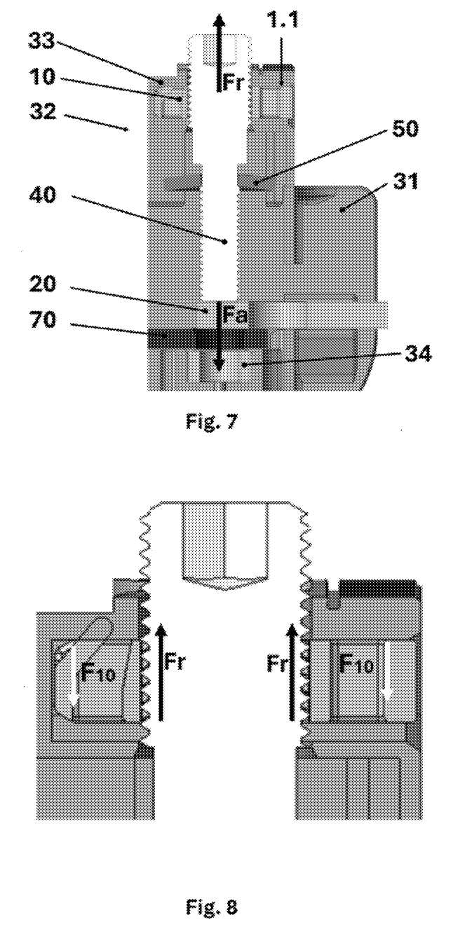

The threaded part 10 is made of plastic. Its body 1 comprises a first side 1.1 and a second side 1.2 opposite to the first side 1.1, a threaded hole 2 extending perpendicularly from the first side 1.1 to the second side 1.2, and one groove 3. The body 1 is configured to fit into the terminal pocket 60 of the contactor 30 while maintaining the first side 1.1 facing the terminal screw 40 (shown in FIG. 7). The body 1 comprises expanding elements 1.3 extending beyond the first side 1.1 and configured to expand within the terminal pocket 60, and locking elements 1.4 configured to lock the threaded part 10 in the terminal pocket 60.

The threaded hole 2 is perpendicular to the direction of slide-in into the terminal pocket 60, and it is positioned in the centre of the body 1. The groove 3 extends from the first side 1.1 toward the second side 1.2 of the body 1 such that a depth of the groove 3 is smaller than a thickness of the body 1 and the groove 3 extends over a thread of the threaded hole 2. The groove 3 is aligned symmetrically with the threaded hole 2 and it is generally in the middle of the length of the body 1.

The depth of the groove 3 is greater than 50% of the thickness of the body 1. The significant difference in the thickness of the component means that the threaded part 10 bends under mounting forces in the area below the groove 3.

The threaded hole 2 comprises two recesses 4 along its length, positioned on opposite sides of the threaded hole 2 and oriented 90 degrees offset from the groove 3 relative to the threaded hole 2. A depth of recesses 4 is greater than a depth of a thread of the threaded hole 2. In other embodiments (not shown), the recesses 4 may be only in the part of the thread - from the first side 1.1 of the body 1 towards the second side 1.2 of it. It is in this area that the threaded part 10 will tend to clamp most tightly on the terminal screw 40 during operation. Alternatively, instead of recesses 4, additional grooves 3 can be made in this area (not shown).

FIG. 7 depicts a cross section of a faulty assembled screw connecting terminal 32 in the contactor 30 with the misaligned ferrule 20. The contactor 30 (see FIG. 2) comprises an insulating body 31 comprising a cover 33, an operating coil housed in the insulating body 31, means of modular connection of the coil to an external circuit so that the coil may be powered, three pairs of screw connecting terminals 32, wherein the screw connecting terminal 32 comprises the terminal screw 40, the fixed contact 70, a spring means 50 (contact lock washer), a nut 34. a threaded part (10) depicted on FIGS. 5 and 6.

The threaded part 10 is positioned in the terminal pocket 60. The body 1 is configured to fit into the terminal pocket 60, and the threaded hole 2 is oriented perpendicular to the direction in which the threaded part 10 slides into the terminal pocket 60.

In other embodiments not shown, the threaded part can be molded into an insulation body 31, or the cover 33 of it. It may also be a single part with one of these components.

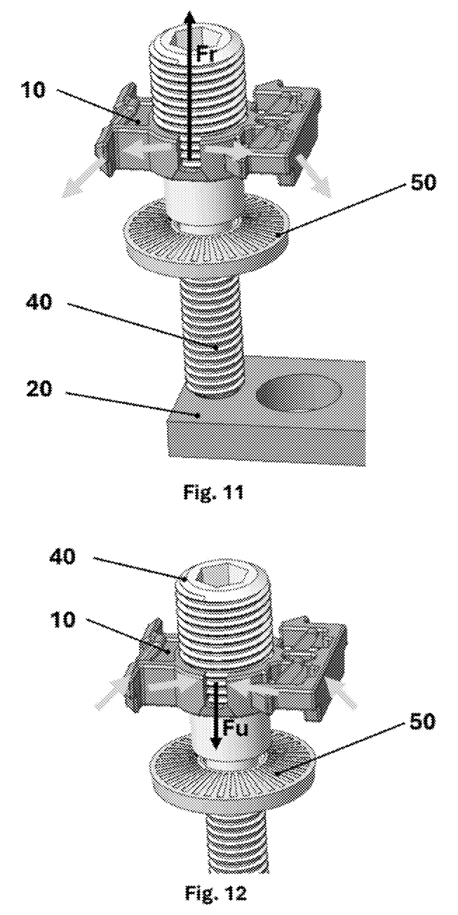

During installation process the terminal screw 40 presses against the ferrule 20 - arrow Fa illustrates the application and direction of an action force on the terminal screw 40. An arrow Fr indicates the direction of a reaction force, which represents the total force exerted by the terminal screw 40 on the threaded part 10 through the threaded connection. As a result of the reaction force, contorting forces resulting from the pressure of the expanding elements 1.3 on the terminal pocket 60 also begin to act on the threaded part 10 - the direction and approximate point of application are indicated by arrows F10 (shown in FIG. 8). The threaded part 10 deforms, as shown by the arrows in FIG. 11. This deformation causes the threaded connection between the elements to loosen, preventing damage to either component in case of incorrect positioning. The recesses 4 help to release the terminal screw 40, when the forces increase. Such deformations of the threaded part 10 are possible in a situation where there is a space left in the terminal pocket 60. FIGS. 7 and 8 shows a simplified drawing – in reality, the expanding elements 1.3 would push the threaded part 10 away from the upper surface of the terminal pocket 60, leaving space for the insert to expand. In other embodiments (not shown) – the space can be preserved with the right terminal pocket 60 profile or expansion elements inside the terminal pocket 60.

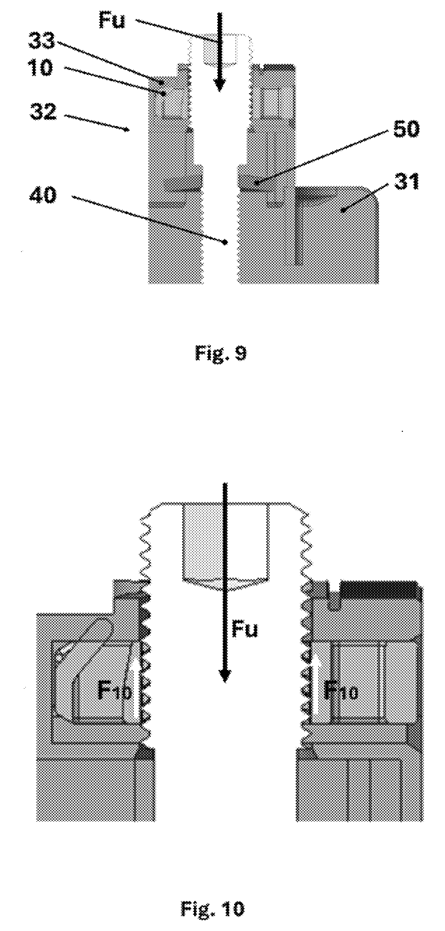

FIG. 9 depicts a cross section of screw connecting terminal 32 in cover 33 during manual process of unscrewing. The arrow Fu indicates the direction of the unscrewing force, which represents the total force exerted by terminal screw 40 on the threaded part 10 through the threaded connection. The threaded part 10 deforms, as indicated by the arrows in FIG. 12. This deformation enhances the insert’s grip on the terminal screw 40, thereby increasing the load capacity of the threaded connection.

The present disclosure describes embodiments that address the challenge of providing a threaded part that is capable of withstanding the preload of the terminal screw, while also being structurally designed to minimize the risk of damage to the contactor in the event of excessive mounting force, which may result from improper installation of the ferrule. The proposed solution introduces a novel approach utilizing a compliant threaded part design, which achieves its compliance along the axis of an applied groove. During assembly, if the terminal screw applies excessive force against the threaded part, the threaded part can “open,” releasing the threaded connection. Conversely, during the unscrewing, under reverse forces—when preload exists in the threaded connection—the insert’s compliance allows it to clamp against the terminal screw. This results in a significant difference in the connection’s load-bearing capacity between the screwing and unscrewing directions.

The proposed solutions regarding the geometry and positioning of the groove are particularly advantageous. The insert can maintain the desired compliance when there is sufficient space within the terminal pocket to allow for deformation. Such space can be provided by design, for example, by incorporating recesses in the terminal pocket in areas where controlled deformation is intended. Alternatively, expansion elements can be integrated into the insert, as described above. Likewise, similar expansion elements may be applied on the terminal pocket side to achieve the same effect.

The clamping effect of the threaded part may be excessive during screwing process. The force required to screw the system together may become excessively high. The solution to this problem involves incorporating recesses in the thread, specifically in areas where the thread would be particularly prone to jamming.

Preferably the at least one groove extends over an entire width of the body crossing the threaded hole.

Preferably the at least one groove is aligned symmetrically with the threaded hole and the body.

Preferably the threaded hole is positioned in the centre of the body.

Preferably the depth of the at least one groove is greater than 50% of the thickness of the body.

In one embodiment the threaded hole comprises at least one recess extending from the first side toward the second side of the body and extends over at least part of a thread of the threaded hole.

In one of the preferred embodiments the body comprises an expanding element extending beyond the first side of the body and configured to expand within the terminal pocket.

Preferably two recesses are positioned on opposite sides of the threaded hole such that an angle between the recess and each of the at least one groove is 90 degrees.

The subject-matter of the invention also provides contactor comprising an insulating body comprising a cover, an operating coil housed in the insulating body, means of modular connection of the coil to an external circuit so that the coil may be powered, at least a pair of screw connecting terminals, and an at least one of screw connecting terminals comprising a terminal screw, a fixed contact, and a threaded part according to disclosure provided above. The insulation body comprises a terminal pocket, and the threaded part is positioned in the terminal pocket.

Preferably the threaded part is in form of an insert, and the body is configured to fit into the terminal pocket, and the threaded hole is oriented perpendicular to the direction in which the threaded part slides into the terminal pocket.

Preferably the threaded part is molded into the terminal pocket.

Preferably the cover comprises the terminal pocket, and the threaded part is a single part with the cover.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A threaded part for use with a contactor terminal screw, comprising:
a body comprising a first side and a second side opposite to the first side;
a threaded hole extending perpendicularly through the body from the first side to the second side; and
at least one groove formed in the body;
wherein the body is configured to fit into a terminal pocket with the first side oriented toward a terminal screw of the terminal pocket;
wherein the threaded hole is oriented toward the terminal screw and
the at least one groove extends from the first side toward the second side of the body such that a depth of the at least one groove is smaller than a thickness of the body; and
wherein the at least one groove extends over at least a thread of the threaded hole.

2. The threaded part of claim 1, wherein the at least one groove extends over an entire width of the body crossing the threaded hole.

3. The threaded part of claim 1, wherein the at least one groove is aligned symmetrically with the threaded hole.

4. The threaded part of claim 1, wherein the threaded hole is centrally disposed relative to the body.

5. The threaded part of claim 1, wherein the depth of the at least one groove is greater than 50% of the thickness of the body.

6. The threaded part of claim 1, wherein the threaded hole comprises at least one recess extending from the first side toward the second side of the body and extends over at least part of a thread of the threaded hole.

7. The threaded part of claim 1, wherein the body comprises an expanding element extending beyond the first side of the body and configured to expand within the terminal pocket.

8. The threaded part of claim 7, wherein two recesses are positioned on opposite sides of the threaded hole such that an angle between the recess and each of the at least one groove is 90 degrees.

9. A contactor, comprising:
an insulating body comprising a cover;
an operating coil housed in the insulating body;
means for modular connection of the coil to an external circuit so that the coil may be powered;
at least a pair of screw connecting terminals; and
at least one screw connecting terminal comprising a terminal screw, a fixed contact, and a threaded part;
wherein the threaded part is positioned in the terminal pocket; and
wherein the threaded part comprises:
a body comprising a first side and a second side opposite to the first side;
a threaded hole extending perpendicularly through the body from the first side to the second side; and
at least one groove formed in the body;
wherein the body is configured to fit into a terminal pocket with the first side oriented toward a terminal screw of the terminal pocket;
wherein the threaded hole is oriented toward the terminal screw and
the at least one groove extends from the first side toward the second side of the body such that a depth of the at least one groove is smaller than a thickness of the body; and
wherein the at least one groove extends over at least a thread of the threaded hole.

10. The contactor of claim 9, wherein the threaded part is an insert, wherein the body is configured to fit into the terminal pocket, and wherein the threaded hole is oriented perpendicular to the direction in which the threaded part slides into the terminal pocket.

11. The contactor of claim 9, wherein the threaded part is molded into the terminal pocket.

12. The contactor of claim 9, wherein the cover comprises the terminal pocket, and the threaded part is a single part with the cover.
